(19) United States
(12) Patent Application Publication
(10) Pub. No.: US 2004/0093507 A1
(43) Pub. Date: May 13, 2004

(54) Verification of the integrity of a software code executed by an integrated processor

(76) Inventors: Stephan Courcambeck, Saint Cyr Sur Mer (FR); William Orlando, Peynier (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/607,365

(22) Filed: Jun. 26, 2003

(30) Foreign Application Priority Data
Jun. 26, 2002 (FR) 02/07952

(51) Int. Cl. G06F 12/14

(52) U.S. Cl. 713/193

(57) ABSTRACT

A circuit for verifying the integrity of a software code executed by a processor, comprising transferring, by blocks, the software code from a storage memory external to the processor and of executing, in parallel with the execution of the software code, an algorithm of verification of the software code by means of a dedicated circuit, separate from said processor for executing the software code.

### BACKGROUND OF THE INVENTION

1. Field of the Invention

The present invention generally relates to the execution of programs (software codes) by an integrated microprocessor. The present invention more specifically relates to the execution of a software code stored outside (in an external memory) of the integrated processor, and to the verification of the integrity or of the authenticity of the software code received by the processor for execution.

2. Discussion of the Related Art

An example of application of the present invention relates to decoders of various data (for example, digital television signal decoders) which handle a secret authentication key linked to the integrated processor to execute a software code stored in an external memory. More generally, the present invention applies to any system (for example, personal computers or PDAs) likely to execute programs or applications stored in a memory external to the integrated processor, and for which the authenticity of the executed software code is desired to be ensured.

A problem which arises upon execution of a software code, stored in a memory external to an integrated processor executing the code, is that an unscrupulous user or a pirate is likely to replace the external memory (its content) either by emulation or by physically replacing of the circuit, to have the integrated processor execute unauthorized programs. Symmetrically, external memories may also be pirated by unscrupulous users which then set about having the software codes executed by other integrated processors than those for which they have been dedicated.

To protect the software code upon execution thereof, a periodic verification of this code based on an authentication key stored in the memory and/or in the integrated circuit, for example, upon initial storage of the program in the external memory, is conventionally provided.

A disadvantage of such a solution is that the verification periods generally have to be spaced apart to avoid disturbing the very operation of the program. Such a time spacing introduces a weakness in the verification system since it allows for a synchronous switching, during the program execution, between a pirate software and the valid software contained in two distinct memories, possibly with the intervention of an emulator.

The software code stored in the external memory may or not have been stored by processes secured against possible piracies. The present invention preferentially applies to the case where the program is stored in cyphered manner in the memory external to the execution processor and is, upon storage, made dependent from the integrated execution processor with which the memory is associated. In this case, the software code is submitted, before being stored in the external memory, to a first authenticity control, generally by so-called private key and public key asymmetrical procedures. The software code is moreover stored in the memory by being cyphered. The key of this cyphering may be different from the key used for the authenticity verification of the program in its initial control.

Among the applications of the present invention, the case of executable programs downloaded by a device in which these programs must be stored (computer, video and/or audio data, device provided with a downloadable program execution processor, etc.) should be noted. The downloading may for example use the Internet, satellite broadcast transmissions, or dedicated telecommunication lines.

### SUMMARY OF THE INVENTION

The present invention aims at providing a novel technique for verifying the integrity or the authenticity of a software code upon execution thereof, in particular, while this software code is stored in a memory external to the integrated circuit executing it.

The present invention more specifically aims at providing a solution which enables integral and parallel verification of the code without disturbing the operation of the application.

The present invention also aims at providing a solution which is compatible with a cyphering of the software code upon initial storage in the external memory.

The present invention also aims at providing a solution which does not enable piracy of the software code by detection of the verification periodicity.

The present invention also aims at enabling verification of a software initialization code of the integrated processor upon power-on.

The present invention also aims at providing a solution which is compatible with a direct random access to the external memory.

To achieve these and other objects, the present invention provides an integrated circuit of execution of a software code stored in a memory external to this integrated circuit and comprising:

a processor of execution of this software code;

a dedicated circuit, separate from the execution processor, to control block by block the integrity of the software code stored in the external memory, as it is being read for execution; and

a cache memory of temporary storage of the software code for use by the execution processor and/or by said dedicated circuit.

According to an embodiment of the present invention, the integrated circuit comprises a software code cyphering/decyphering circuit based on a secret key specific to the integrated circuit.

According to an embodiment of the present invention, the integrated circuit further comprises a direct memory access controller for managing the accesses to a memory bus of communication between the integrated circuit and the external memory, said controller transferring the software code, block by block, when this bus is not used by the execution processor.

According to an embodiment of the present invention, said external memory is a dual-port memory, a first access being dedicated to the execution processor while a second access is dedicated to the integrity control circuit.

According to an embodiment of the present invention, said dedicated integrity control circuit is formed of a state machine in wired logic.

According to an embodiment of the present invention, said dedicated integrity control circuit is a secondary processor separate from the execution processor.

According to an embodiment of the present invention, the software code blocks are read from the external memory during periods where said execution processor does not need to have access to a shared memory bus.

The foregoing objects, features and advantages of the present invention, will be discussed in detail in the following non-limiting description of specific embodiments in connection with the accompanying drawings.

### BRIEF DESCRIPTION OF THE DRAWINGS

FIG. 1 very schematically shows in the form of blocks an embodiment of an integrated circuit containing a processor and the circuits for implementing the method according to the present invention; and

FIG. 2 partially and very schematically shows, still in the form of blocks, a second embodiment of a software code execution and authenticity verification integrated circuit according to the present invention.

### DETAILED DESCRIPTION

Same elements have been designated with same reference numerals in the different drawings. For clarity, only those steps of the method and those elements of the circuits that are necessary to the understanding of the present invention have been shown in the drawings and will be described hereafter. In particular, the processings performed by the processor concerning the actual software code have not been detailed and are no object of the present invention. Said invention applies whatever the finality of the software code, the authenticity of which is verified upon execution according to the present invention. Further, the actual cyphering and decyphering methods have not been detailed since the present invention may be implemented with any secret key cyphering method as will be explained hereafter.

A feature of the present invention is to use an element separate from the integrated processor to verify the integrity of the software code executed by said processor, this separate element being dedicated to such a verification. Another feature of the present invention is to transfer the software code, by blocks, from the external memory to the verification element, without using the processor of execution of this code. For this purpose, the data and address transfer memory bus, used by the execution processor, must not be used to transfer software code blocks to be verified when this execution processor needs this bus to have access to the memory.

A first solution would be to transfer the entire software code from its storage memory (for example, an external memory) to a memory integrated to the processor. Such a solution is in practice unrealistic due to the redhibitory size of the memory which would then have to be integrated with the execution processor.

To manage the shared memory bus without adversely affecting the execution of the software code by the execution processor, a direct memory access controller (DMA) is preferentially used. Such a controller is here used for its shared bus control function. A DMA controller takes the hand over the memory bus in a transparent way for the software code execution processor when the processor does not require it.

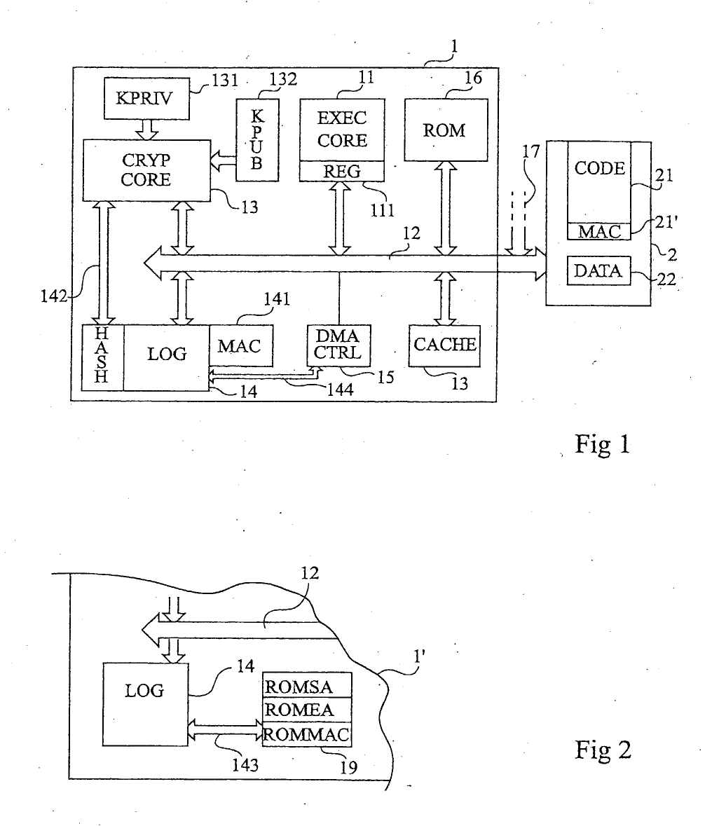

FIG. 1 very schematically shows in the form of blocks an embodiment of an integrated circuit 1 according to the present invention, adapted to the implementation of the method for verifying the integrity of a software code stored in a memory 2 external to integrated circuit 1.

The software code is stored in a memory segment or block (block 21, CODE) of memory 2 which contains, among others, also another segment (block 22, DATA) for the storage of the processed data. External memory 2 also contains in segment 21 or in another part (block 21′, MAC) one or several message authentication codes or one or several signatures of the program blocks stored in segment 21 to enable authentication thereof, as they are being executed, by integrated circuit 1. A MAC code is the result of an algorithm applied to a data flow, taking a key into account. A signature is the result of a Hash algorithm applied to a data flow without taking a key into account, but cyphered at the output by a generally symmetrical key.

As will be seen hereafter, the software code stored in memory 2 may be stored in a cyphered manner by using a key specific to integrated circuit 1. The cyphering of the actual software code is then performed preferentially after having decrypted the application on installation while said application is encrypted by means of another key.

As for integrated circuit 1, it comprises for the implementation of the present invention a processor for executing the software code (block 11, EXEC CORE) associated with an input-output register 111 (REG) connected to a bus 12 shared by the circuits comprised in integrated circuit 1. Bus 12 is a memory bus and thus communicates with memory 2 external to the integrated circuit. For simplification, a single bus 12 has been shown. It should however be noted that memory 12 also comprises an address bus communicating with circuit 1 to fetch the data (software code to be executed or actual data) from the appropriate areas thereof and that appropriate control buses connect the different elements.

Circuit 1 also comprises a cache memory 18 (CACHE) communicating with bus 12. The function of the cache memory is, conventionally, to store the software code lines to be executed while these code lines are transferred, by blocks, from external memory 2. A cyphering circuit 13 (CRYP CORE) associated with elements (for example, registers or the like) of storage of a private key (block 131, KPRIV) specific to integrated circuit 1 and of one or several public keys (blocks 132, KPUB) is, according to this embodiment of the present invention, provided in circuit 1 to cypher/decypher the software code contained in memory 2. As will be seen hereafter, circuit 13 is not only used upon installation of the program downloaded from the outside of the system but also upon execution of this code for the integrity verification specific to the present invention. Cyphering circuit 13 communicates with bus 12 and is formed, preferentially, of a state machine in wired logic. As an alternative, it may however be a processor, preferably, separate from processor 11.

According to a feature of the present invention, circuit 1 also comprises an element 14 (LOG, HASH) for verifying the integrity of the software code being executed. Circuit 14 is, according to the preferred embodiment illustrated in FIG. 1, formed of a state machine in wired logic communicating with bus 12. As an alternative, it may be a processor dedicated to this function and separate from software code execution processor 11. Element 14 is associated with a register 141 of temporary storage of the MAC code or of the signature of the software code block being authenticated, or of a table of MAC codes or of signatures of blocks of the software code. Circuit 14 also directly communicates with circuit 13 and implements a cryptography function, preferably a so-called Hash function, conventional per se. In the case of a control by MAC code, circuit 14 further contains a key (not shown) specific to the integrated circuit. In the case of a signature control, key KPRIV of register 131 is used.

According to the shown embodiment of the present invention, circuit 1 further integrates a DMA controlled 15 (DMA CTRL) in charge of managing the exchanges over memory bus 12, and a ROM (block 16) containing, for example, the initialization software code of circuit 1.

Other conventional components equip circuit 1 according to the application. These components have not been shown and are no object of the present invention. The present invention applies whatever the destination of integrated circuit 1, provided that said circuit has the function of executing a software code stored in an external memory 2, the integrity of which is desired to be controlled upon execution.

An example of implementation of the method according to the present invention will be described hereafter for the installation of a program or software code, that is, its cyphering before storage in segment 21 of memory 2, based on key KPRIV specific to integrated circuit 1.

It is for example assumed that the application is downloaded from a provider external to the integrated circuit. It will be, for example, an Internet downloading or a downloading by satellite broadcast channels or the like. This downloading is symbolized in FIG. 1 by an access 17 on memory bus 12.

According to a first implementation mode, the software code to be stored is downloaded with its signature (encrypted by the provider of the application based on a private key). The encryption has been performed based on an asymmetrical algorithm (for example, a Hash function) based on the sending of a key by the provider or by circuit 1 according to the key with which the software code is encrypted. In the example of FIG. 1, it is assumed that circuit 1 receives a public key KPUB (block 132) from the provider having encrypted the application code. Key KPUB is then used by circuit 13 to decode the encrypted application, be it read from memory 2 after a block downloading or decrypted in real time by a downloading over a bus 17. As an alternative, a symmetrical algorithm is used, key KPUB being then used to decypher a decryption key of the symmetrical algorithm. Up to this point, circuit 1 executes conventional steps of decryption of a program encrypted by a private and public key algorithm.

The installation program (for example, stored in ROM 16) provides integrity control circuit 14 with the beginning and end addresses, in memory 2, of the software code to be decrypted for installation and to be stored cyphered. It is here assumed that the application to be installed thus has previously been stored in memory 2. Circuit 14 then sends a request to the DMA controller to extract the content of memory 2 between these addresses. Further, the encrypted signature (for example, contained in segment 21′) of the application is sent to cyphering/decyphering circuit 13 which decrypts this signature by using key KPUB. It should be noted that key KPUB can transit in clear on bus 12 since it here is a public key. However, once decrypted, the signature of the software code transits, towards circuit 14, over a dedicated link 142.

Circuit 14 then calculates the result of the Hash function applied to the software code which is provided thereto under control of DMA controller 15, and compares it with the result of the signature decrypted by circuit 13. If the results are identical, the system (more specifically, the installation program), allows installation of the application which is then memorized in memory 2. If not, it implements the usual procedures of rejection of an unauthorized application (for example, erasing of the corresponding memory area).

In a second installation phase, the software code may be cyphered with private key KPRIV of the integrated circuit chip before being stored in memory 2. Key KPRIV is then preferentially a key specific to the chip. For example, it is a binary code at least partially originating from a physical parameter network linked to the integrated circuit. As an alternative, it is a key of a symmetrical algorithm.

In practice, the first and second installation phases may be interleaved.

The program is installed between beginning and end addresses in segment 21 of memory 2. The division of the program into blocks, preferentially of identical sizes, is performed in this second initialization phase. This division is provided in the installation program as well as the addition of possible conventional initialization and control instructions. The beginning and end addresses of each block are stored in a specific area of memory 2. This memory area is then first read and beginning and end addresses are sent to logic circuit 14, which provides a request to DMA controller 15 to read segment 21 of memory 2 between these two addresses. Circuit 14 calculates (after a possible decryption if this has not been separately performed) the result of a Hash function applied to the code or to the read code block and sends the result (signature) to cyphering circuit 13 for it to be cyphered with private key KPRW (or another key). The cyphered result forms code MAC of the block and is transferred, by bus 12, into external memory 2, to be recorded in segment 21′, while the lines of the software code block cyphered by key KPRIV are stored in segment 21.

Already upon installation, the use of the DMA controller enables executing all the cyphering functions without using cycle time of execution processor 11. In particular, logic circuit 14 is allowed to provide a request to the DMA controller to read the content of external memory 2 between addresses defined by an address table linked to the application and downloaded by the application provider.

Of course, in the entire installation, cache memory 18 is used for transfers. This use and the necessary controls are within the abilities of those skilled in the art based on the functional indications given hereabove.

Once the software code has been installed by being cyphered and associated with MAC codes in blocks (instruction groups), it can, according to the present invention, be controlled at each of its executions as follows.

At each program starting, the table of the beginning and end addresses of the cyphered blocks is read and stored, either in registers associated with circuit 14, or in cache memory 18.

According to a first implementation mode, for each instruction, circuit 14 verifies the pointer of execution processor 11 to determine whether the software code block read from cache memory 18 has or not been verified. If not, it sends a request to the DMA controller for reading the block containing the instruction of interest from memory 2 as well as the MAC code or the corresponding signature. The MAC code or the signature is stored in register 141 and controller 15 transfers the block sequentially to circuit 14 in parallel with its storage in cache memory 18 to be made available to the execution processor. In the case of MAC codes, circuit 14 directly provides an authentication signal by comparing the calculated code with the expected MAC code. In the case of a signature, circuit 14 calculates the Hash function over the entire block and transfers the obtained result to circuit 13 (over direct connection 142). The latter cyphers this signature by means of private key KPRIV and returns the cyphered result to circuit 14. Said circuit then compares the cyphered result with the expected signature contained in its register 141. In case of an identity, execution processor 11 is allowed to proceed. Otherwise, a no-integrity signal is sent thereto.

Logic circuit 14 preferentially is a free-wheel state machine in wired logic, that is, it is in a condition of permanent operation.

According to a second implementation mode, processor 11 knows that it starts a new block of the application code and then starts the verification. Processor 11 then provides a beginning and an end address as well as the block size to circuit 14. The reading from memory 2 is always performed without using processor 11 due to DMA controller 15 which then provides the block corresponding to logic circuit 14.

According to an alternative implementation, a temporization with respect to each position change of the current pointer in execution processor 11, or a temporization with respect to each block change detected thereby, is provided.

It may also be provided to spy on the address bus to determine the occurrence of an instruction coming from an unverified block.

According to the preferred embodiment of the present invention, the MAC codes or the signatures are, upon installation, stored in a separate table (segment 21′) of memory 2. Controller 15 then reads, at each beginning or end of a block that it transfers to cache memory 18 and that it submits to circuit 14, the MAC code or the signature of the concerned block and stores this code in register 141.

It should be noted that the MAC code or the signature is cyphered by the integrated circuit chip upon installation and is thus different from chip to chip. On memory bus 12, the application codes remain cyphered. In the case of a signature, this is made possible by the use of a specific connection 142 between logic circuit 14 and cyphering core 13. An advantage then is that the software code block signature cannot be pirated by spying on memory bus 12.

The size of the blocks of the application code processed by logic circuit 14 depends on the application and among others, on the transfer rate of the DMA controller and on the control time necessary to circuit 14. The smaller the memory block, the more necessary it will be to have often access to memory 2 and thus to require accesses to the bus by DMA controller 15. However, since said controller manages memory bus 12 to use it when it is not used by processor 11, this is not necessarily disturbing.

To implement the method of the present invention, circuit 1 must especially be equipped with the following elements:

a dedicated connection (144) between DMA controller 15 and circuit 14 which is not accessible to execution processor 11; and

in the case of a signature control, a dedicated connection (142) between circuit 14 and circuit 13, so that the Hash function never clearly appears on data bus 12. This connection is not necessary in case of a control by MAC code.

FIG. 2 illustrates an alternative implementation of an integrated circuit 1 according to the present invention adapted to also verify, by means of circuit 14, the integrity of the boot program of circuit 1.

FIG. 2 only partially shows circuit 1. Only logic circuit 14 (LOG) and the direct connection 143 that it has, according to this embodiment, with a memory table 19 (for example registers), have been shown. Circuit 14 loads on a dedicated line (not shown) the internal parameters of the ROM from an area of ROM 16 which is dedicated thereto and which contains the beginning address in ROM 16 of the start program (ROMSA), the end address (ROMEA) of the start program as well as a MAC code (ROMMAC) or a signature of the program stored in the ROM. Circuit 14 then sends a request to DMA controller 15 to read the content of memory 16 between the beginning and end addresses. In the case of a signature control, it applies a Hash function to this content and provides the result to cyphering circuit 13. Circuit 13 cyphers the result (signature) of the Hash function by using private key KPRIV contained in register 131 and provides the cyphered result to circuit 14. Said circuit then verifies that this cyphered result corresponds to the expected signature. If it does, it allows the program starting. Otherwise, it executes the usual blocking functions. The initialization program may be divided into blocks (according to its length). In the case of a control by MAC code, circuit 14 verifies the identity between a MAC code that it calculates and the expected ROMMAC code.

To implement the embodiment of FIG. 2, circuit 1 must be equipped (in addition to the elements described in relation with FIG. 1), especially with a dedicated line (not shown) between the table storing the internal parameters of the ROM and circuit 14. Memory controller 15 enables circuit 14 to have access to ROM 16 without using processor 11.

Preferably, circuit 14 comprises a means for preventing, by hardware means, the code execution if it detects an integrity default.

Preferably, to avoid slowing down the program execution, said execution is authorized during integrity calculations performed in parallel. However, it must then be ensured that the MAC code or the signature be provided within a reasonable delay (with respect to the piracy capacities). It will for example be possible to use a temporization or prevent any interruption of the channel of the DMA controller used for the verification.

Of course, the present invention is likely to have various alterations, modifications, and improvement which will readily occur to those skilled in the art. In particular, the practical implementation of the present invention is within the abilities of those skilled in the art based on the functional indications given hereabove. Further, what has been discussed in relation with a DMA controller may be transposed to a dual-access memory or to a memory equipped with its own controller. For example, in the case of a dual-access memory, an access will be reserved to core 11 of the processor while an access will be reserved to integrity verification logic circuit 14.

Further, the choice of the encryption or cyphering/decyphering algorithms as well as of the Hash function is within the abilities of those skilled in the art based on the functional indications given hereabove and on the known algorithms. Of course, the Hash function implemented by circuit 14 in the integrity control and the cyphering function implemented by circuit 13 must be compatible with those implemented upon installation. For example, reference may be made to the works relative to cryptography to selected the desired functions (see Bruce Schneier, “Cryptographie appliquée”, published by WILEY, ISBN 2-84-180-036-9).

Finally, the forming of an integrated circuit provided with a DMA controller conformal to the preferred embodiment of the present invention may be inspired, for example, from U.S. Pat. No. 4,240,138.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An integrated circuit of execution of a software code stored in a memory (2) external to this integrated circuit and comprising a processor (11) of execution of this software code, comprising:
a dedicated circuit (14), separate from the execution processor, to control block by block the integrity of the software code stored in the external memory, as it is being read for execution; and
a cache memory (18) of temporary storage of the software code for use by the execution processor and/or by said dedicated circuit.

2. The circuit of claim 1, comprising a cyphering/decyphering circuit (13) of the software code based on a secret key (KPRIV) specific to the integrated circuit.

3. The circuit of claim 1, further comprising a direct memory access controller (15) for managing the accesses to a memory bus (12) of communication between the integrated circuit (1) and the external memory (2), said controller transferring the software code, block by block, when this bus is not used by the execution processor (11).

4. The circuit of claim 1, wherein said external memory (2) is a dual-port memory, a first access being dedicated to the execution processor (11) while a second access is dedicated to the integrity control circuit (14).

5. The circuit of claim 1, wherein said dedicated integrity control circuit (14) is formed of a state machine in wired logic.

6. The circuit of claim 1, wherein said dedicated integrity control circuit is a secondary processor separate from the execution processor (11).

7. The circuit of claim 1, wherein the software code blocks are read from the external memory during periods where said execution processor does not need to have access to a shared memory bus.
